(19) United States
(12) Patent Application Publication
(10) Pub. No.: US 2013/0137307 A1
(43) Pub. Date: May 30, 2013

(54) PLUG CONNECTOR, RECEPTACLE CONNECTOR AND ELECTRICAL CONNECTOR ASSEMBLY

(71) Applicants: SHENG-YUAN HUANG, New Taipei (TW); Sheng-nan Yu, New Taipei (TW); Chih-hsien Chiang, New Taipei (TW)

(72) Inventors: SHENG-YUAN HUANG, New Taipei (TW); Sheng-nan Yu, New Taipei (TW); Chih-hsien Chiang, New Taipei (TW)

(73) Assignee: Cheng Uei Precision Industry Co., LTD., New Taipei City (TW)

(21) Appl. No.: 13/304,403

(22) Filed: Nov. 24, 2011

(51) Int. Cl. H01R 24/28

(52) U.S. Cl. 439/660

(57) ABSTRACT

A plug connector, a receptacle connector and an electrical connector assembly are provided. The receptacle connector includes a receptacle housing and a plurality of receptacle terminals. Each receptacle terminal includes a first and a second wing portions, and a first and a second edge portions. The receptacle housing disposes shoulders respectively corresponding to the first and the second wing portions. The plug connector includes a plug housing and a plurality of plug terminal. Each plug terminal includes a first and a second contact portions. When the plug connector and the receptacle connector are mated together, the plug terminal and the receptacle terminal can realize a two-position contact for providing a stable signal transmission. When pulling out the plug connector, the shoulders of the receptacle housing can block the receptacle terminal to be pulled out thereby ensuring the stable combination of the receptacle terminal and the receptacle housing.

### BACKGROUND OF THE INVENTION

1. Field of the Invention

The present invention relates to a plug connector, a receptacle connector and an electrical connector assembly, and more particularly to a plug connector and a receptacle connector being mated together and to an electrical connector assembly having improved components, being capable of providing a stable combination and forming an electrical connection between two circuit boards.

2. Description of the Prior Art

At present, a connector mainly includes a housing and a plurality of electrical terminals. The connector is mounted on a circuit board for being mated with a complementary connector. By the terminals of the two connectors contacting with each other, the two connectors form an electrical transmission therebetween. Therefore, the configuration of the electrical terminal is one of the main factors of whether the electrical terminal can provide a stable contact. In view of this, the electrical terminal of the traditional connector has an inclined hanging arm for pressing against a complementary terminal, thereby enhancing the engagement accuracy. However, because of the configuration of the inclined hanging arm, the combination of the traditional electrical terminal and the connector is easy to be affected when the complementary connector is pulled out from the connector. Namely, the electrical terminal is easy to escape from the connector or even be pulled out, so this will result in the deformation of the electrical terminal. Moreover, the configuration of the traditional electrical terminal provides only one single position to contact with the complementary terminal, so that it is easy to fail to contact with the complementary terminal when the connector suffers from the factors of the external shocks and the like. That will result in the problems of unstable signal transmission or even signal interruption and so on. These problems are especially easy to occur in a board-to-board connector having multiple electrical terminals

Furthermore, for the traditional board-to-board connector, the electrical terminal and the complementary terminal contact with each other by a hard interference fit produced therebetween. But the hard interference fit cannot provide a stable contact and is easily loosened to result in the bad electrical transmission when the connector is slightly pulled by the external shocks.

### BRIEF SUMMARY OF THE INVENTION

For overcoming above defects, an object of the present invention is to provide a plug connector, a receptacle connector and an electrical connector assembly, which can form a stable connection to provide a stable signal transmission and are not easy to be effected by external shocks, wherein the combination of the receptacle terminal and the receptacle housing can not be affected by the pulling operation of the plug terminal of the plug connector.

To achieve the above object, in accordance with the present invention, a receptacle connector is provided, comprising a receptacle housing, a protruding plate, a plurality of terminal-receiving grooves, two engaging grooves and a plurality of receptacle terminals. The receptacle housing is made of insulating material. The receptacle housing has two opposite end walls, two sidewalls connected to the two end walls, and a bottom plate connecting bottoms of the two end walls and the two sidewalls. The protruding plate stands on the bottom plate and is parallel to and located between the two sidewalls. Two opposite ends of the protruding plate and the two sidewalls are spaced a distance. Each terminal-receiving groove is together defined by the protruding plate, the sidewall and the bottom plate. The terminal-receiving grooves are spaced each other and pass through top and bottom surfaces of the bottom plate and the two sidewalls. The two engaging grooves are respectively formed between the protruding plate and the two sidewalls and are communicated with the terminal-receiving grooves. The receptacle terminals are mounted in the terminal-receiving grooves from the below of the bottom plate. Each receptacle terminal includes a connecting section, a pressing section and a positioning section. The pressing section and the positioning section are respectively bent from two ends of the connecting section and are spaced each other. The positioning section is inverted U-shaped and located in the sidewall of the receptacle housing. The protruding plate forms a resisting wall corresponding to the pressing section. The resisting wall is sloped down from the engaging groove to the inner of the protruding plate. The pressing section is tilted toward the positioning section. The pressing section and the resisting wall maintain an interval. The pressing section disposes at least a first wing portion, and the protruding plate forms a shoulder corresponding to the first wing portion.

To achieve the above object, in accordance with the present invention, a plug connector is provided, comprising a plug housing, an inserting groove and a plurality of plug terminals. The plug housing is made of insulating material. The plug housing has two opposite end walls, two sidewalls connected to the two end walls and spaced each other, and a bottom plate connecting bottoms of the two end walls and the two sidewalls. The two end walls, the two sidewalls and the bottom plate together define the inserting groove. The plug terminals are spaced each other and orderly arranged on the two sidewalls. Each plug terminal includes a latch section, which is U-shaped and forms an interference section and a contact section on two opposite ends thereof. The interference section disposes a first contact portion being adjacent to and opening to the inserting groove. The contact portion disposes a second contact portion, which is concaved inward from one surface of the contacting section. One end of the interference section is further bent and extends to form a solder portion, which is partially located in the bottom plate and which is partially exposed out of the plug housing. The part of the solder portion embedded in the bottom plate is located above the contacting section and is together with the contacting section to clamp the bottom plate.

To achieve the above object, in accordance with the present invention, an electrical connector assembly is provided, comprising a receptacle connector and a plug connector. The receptacle connector comprises a receptacle housing for accommodating a plurality of receptacle terminals. Each receptacle terminal includes at least a first and a second wing portions, and a first and a second edge portions. The receptacle housing disposes shoulders respectively corresponding to the first and the second wing portions. The plug connector comprises a plug housing for accommodating a plurality of plug terminal. Each plug terminal includes a first and a second contact portions. When the plug connector and the receptacle connector are mated together, the first and the second contact portions of the plug terminal correspondingly contact the first and the second edge portions of the receptacle terminal to realize a two-position contact thereby providing a stable signal transmission. When the plug connector is pulled out from the receptacle connector, the first and the second wing portions of the receptacle terminal are respectively blocked by the shoulders to ensure that the assembly of the receptacle terminal and the receptacle housing can not be affected by the pulling force.

### BRIEF DESCRIPTION OF THE DRAWINGS

FIG. 1 is a perspective view of a plug connector and a receptacle connector of an electrical connector assembly of the present invention.

FIG. 2 is an assembly view of FIG. 1.

FIG. 3 is a schematic view of a receptacle terminal of the receptacle connector.

FIG. 4 is a schematic view of a plug terminal of the plug connector.

FIG. 5 is a schematic view of the engagement process of the receptacle terminal and the plug terminal.

FIG. 6 is one sectional view of the receptacle connector.

### DETAILED DESCRIPTION OF THE PREFERRED EMBODIMENTS

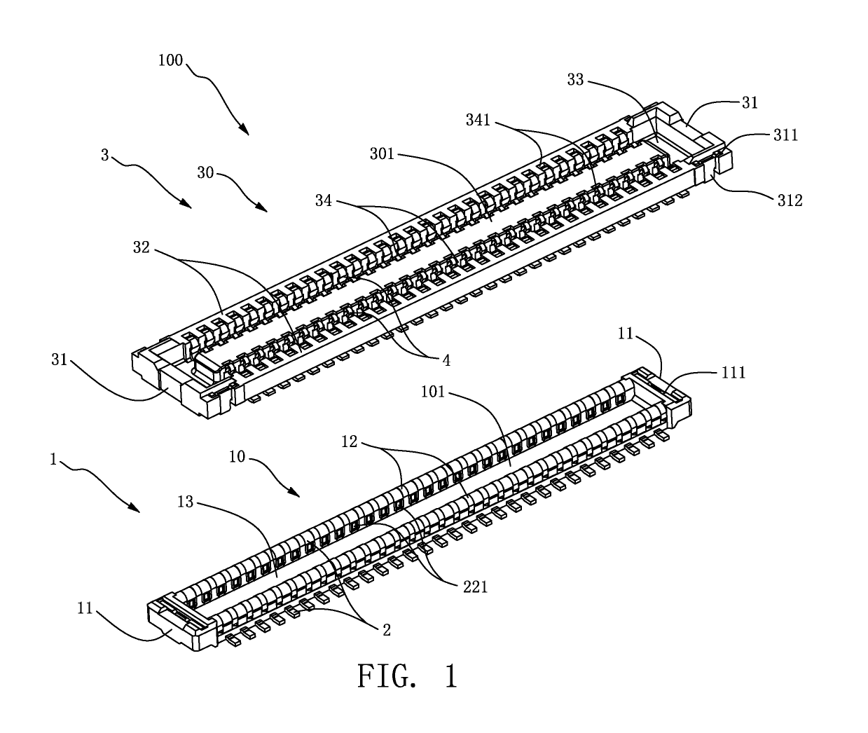

Please refer to FIGS. 1 to 6, which are one preferred embodiment of an electrical connector assembly 100 of the present invention, the electrical connector assembly 100 of the present invention comprises a plug connector 1 and a receptacle connector 3 mated with each other.

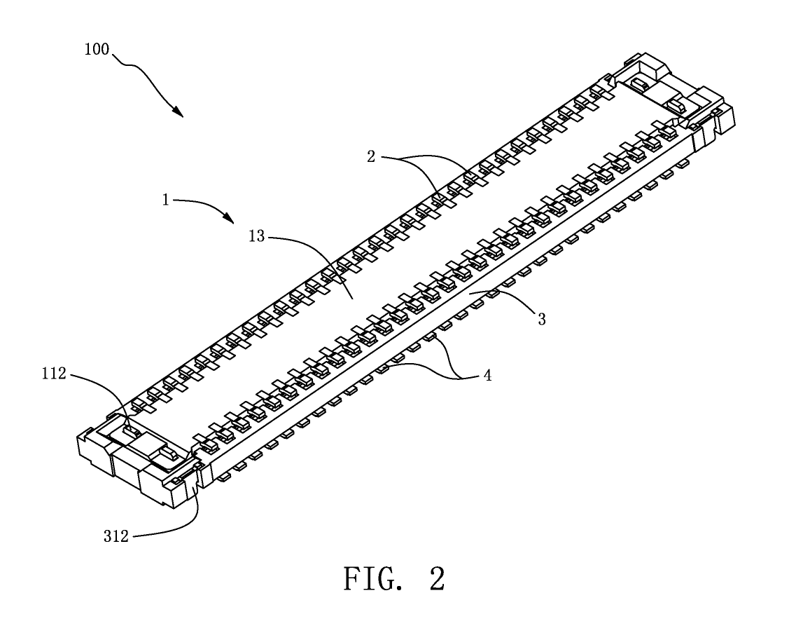

Please refer to FIGS. 1 to 4, the receptacle connector 3 of the electrical connector assembly 100 of the present invention has a flat rectangular shape and comprises a receptacle housing 30 being made of insulating material. The receptacle housing 30 has two opposite end walls 31, two opposite sidewalls 32 being perpendicular to and respectively connected to the two end walls 31, a bottom plate 33 connecting the bottoms of the two end walls 31 and the two sidewalls 32, and a protruding plate 301 standing on the bottom plate 33, being located between the two sidewalls 32 and being parallel to the two sidewalls 32. Two opposite ends of the protruding plate 301 and the two sidewalls 11 are respectively spaced a distance. Each of the two end walls 31 disposes a positioning groove 311 formed outside thereof and passing through a top and bottom surfaces of the end wall 31. A flux member 312 (shown in FIGS. 1 and 2) is mounted in the positioning groove 311 for strengthening the connection of the receptacle housing 30 and a circuit board (not shown in all FIGS.). Moreover, the receptacle connector 3 has two engaging grooves 34 respectively formed between two longitudinal sides of the protruding plate 301 and the two sidewalls 32, and a plurality of terminal-receiving grooves 341 together defined by the protruding plate 301, the two sidewalls 32 and the bottom plate 33. The terminal-receiving grooves 341 are spaced each other and pass through the top and bottom surfaces of the bottom plate 33 and the two sidewalls 32. The receptacle connector 3 further comprises a plurality of receptacle terminals 4 being punched by metal material and mounted into the terminal-receiving grooves 341 from the below of the bottom plate 33.

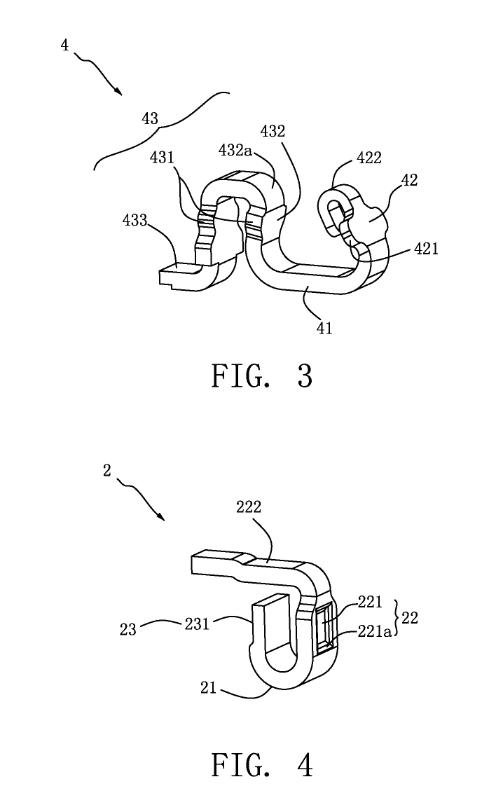

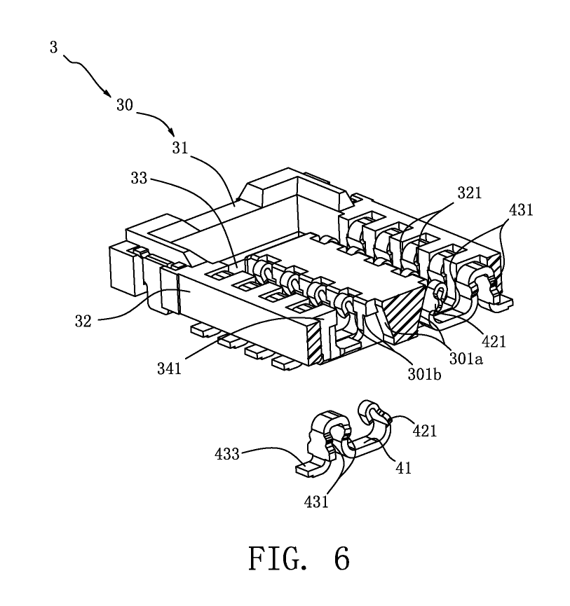

Please refer to FIG. 3, each receptacle terminal 4 includes a connecting section 41, a pressing section 42 and a positioning section 43. The pressing section 42 and the positioning section 43 are respectively bent from two ends of the connecting section 41 and are spaced each other. The positioning section 43 is inverted U-shaped and located in the sidewall 32 of the receptacle housing 30. The connecting section 42 is parallel to the bottom plate 33 of the housing 30. Please refer to FIG. 6, the protruding plate 301 disposes a resisting wall 301a, which stands on the bottom plate and is sloped down from the engaging groove 34 to the inner of the protruding plate 301. The pressing section 42 is tilted toward the positioning section 43. The pressing section 42 and the resisting wall 301a maintain a certain interval.

Please refer to FIGS. 4 and 6, it is particularly mentioned that: the pressing section 42 disposes a first wing portion 421 protruding on two sides thereof and extending toward the two end walls 31 of the receptacle housing 30. The protruding plate 301 forms a shoulder 301b corresponding to the first wing portion 421. The inverted U-shaped positioning section 43 disposes a pair of second wing portions 431 protruding on two sides thereof. Each of the two sidewalls 32 also forms a shoulder 321 corresponding to the second wing portion 431. Moreover, the pressing section 42 further disposes a first edge portion 422, which is formed on one end thereof away from the connecting section 41 and is exposed in the engaging groove 34. The positioning section 43 disposes a second edge portion 432, which is adjacent to the engaging groove 34 and is sloped downward from the engaging groove 34 to the sidewall 32 so that forming a ridge portion 432a. The ridge portion 432a is exposed in the engaging groove 34.

Please refer to FIG. 3, in this preferred embodiment, the first edge portion 422 is bent to form an arc surface, but the configuration thereof should not be limited to the arc surface. One end of the positioning section 43 opposite to the connecting section 41 is bent to form a solder portion 433 for being soldered onto the circuit board (not shown in all FIGS.).

Please refer to FIGS. 1 and 4, the plug connector 1 comprises a plug housing 10 being rectangular strip-shaped and being made of insulating material. The plug housing 10 has two opposite end walls 11 extending along a short axis thereof, two opposite sidewalls 12 extending along a long axis thereof, and a bottom plate 13 connecting bottoms of the two end walls 11 and the two sidewalls 12. Each of the two end walls 11 disposes a positioning groove 111 passing through a top and bottom surfaces thereof. A flux member 112 (shown in FIG. 2) is mounted in the positioning groove 111 for strengthening the connection of the plug housing 10 and one circuit board (not shown in all FIGS.). The plug connector 1 further comprises an inserting groove 101 together defined by the two end walls 11, the two sidewalls 12 and the bottom plate 13. The plug connector 1 further comprises a plurality of plug terminals 2 being made of metal material and orderly arranged on the two sidewalls 12. Each plug terminal 2 includes a latch section 21 being U-shaped. Two opposite ends of the latch section 21 respectively form an interference section 22 and a contact section 23.

Please refer to FIGS. 1 and 4, the interference section 22 of the plug terminal 2 disposes a first contact portion 221, which is adjacent to and exposed in the inserting groove 101. The contact section 23 disposes a second contact portion 231. One end of the interference section 22 is bent and extends to form a solder portion 222, which is partially located in the bottom plate 13 and which is partially exposed out of the plug housing 10 for being soldered onto the circuit board (not shown in all FIGS.). The part of the solder portion 222 embedded in the bottom plate 13 is located above the contacting section 23, and is together with the contacting section 23 to clamp the bottom plate 10.

Please refer to FIG. 4, in this preferred embodiment, the first contact portion 221 is a recess, which is concaved inward from one surface of the interference section 22. The peripheral edges of the recess 221 are oblique side or arc side 221a for guiding a complementary terminal to be positioned. The second contact portion 231 is concaved inward from one surface of the contacting section 23 to form a platform for increasing the contact area with the complementary terminal. However, the first and the second contact portions 221, 231 should not be limited to above-mentioned configuration. Moreover, the inner surface of the latch section 21 is attached to the two sidewalls 12 of the housing 10 after assembled.

Please refer to FIGS. 3 to 6, when the plug connector 1 and the receptacle connector 3 of the electrical connector assembly 100 are mated together, the protruding plate 301 of the receptacle connector 3 is accommodated in the inserting groove 101 of the plug connector 1, the two sidewalls 12 located two sides of the inserting groove 101 are respectively inserted into the engaging grooves 34 located on two sides of the protruding plate 301, the two end walls 11 of the plug connector 1 are respectively filled into the spaces between the protruding plate 301 and the two end walls 31. In other words, the two end walls 31 and the two sidewalls 32 of the receptacle connector 3 surround the two end walls 11 and the two sidewalls 12 of the plug connector 1.

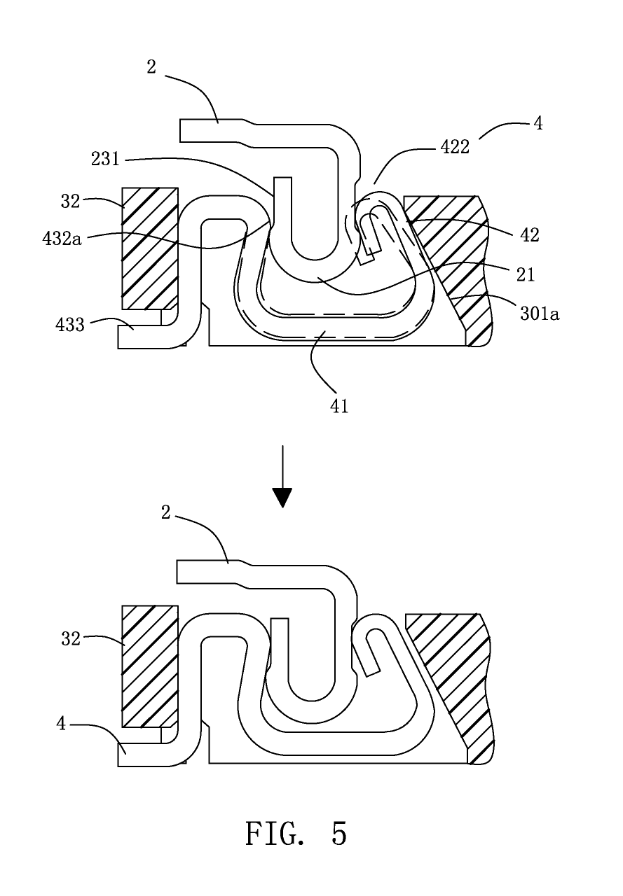

Please refer to FIG. 5, when the plug terminal 2 of the plug connector 1 is inserted into the engaging groove 34, the outer surface of the latch section 21 of the plug terminal 2 first contacts the first edge portion 422 and the ridge portion 432a of the receptacle terminal 4 of the receptacle connector 3. In other words, the first edge portion 422 and the ridge portion 432a will be slightly deformed and gradually opened outward because of clamping and depending against the latch section 21 of the plug terminal 2. Now, the pressing section 42 leans against the resisting wall 301a. With the plug terminal 2 being continuously inserted and finally being positioned, the recess-shaped first contact portion 221 contacts the arc-shaped first edge portion 422, the platform-shaped second contact portion 231 contacts the ridge portion 432a, and the latch section 21 contacts the second edge portion 432. Therefore, the receptacle terminal 4 can stably clamp the plug terminal 2 so that realizing a two-position contact between the plug terminal 2 and the receptacle terminal 4.

Similarly, when the plug connector 1 is pulled out from the receptacle connector 3, the pulling force is transferred to the first edge portion 422 and the ridge portion 432a, so that the receptacle terminal 4 has a trend of being pulled out. But because the first wing portion 421 and the second wing portion 431 are respectively blocked to move upward by the shoulders 301b, 321, the receptacle terminal 4 can not be affected by the pulling of the plug connector 1 and the stable combination of the receptacle terminal 4 and the receptacle housing 30 can be assured.

As described above, the plug connector 1, the receptacle connector 3 and the electrical connector assembly 100 of the present invention have the aid of the configuration of the plug terminal 2 and the receptacle terminal 4 to realize a two-position contact for providing a stable signal transmission, assuring a stable combination of the receptacle terminal 4 and the receptacle housing 30 and being not easy to be affected by the inserting and pulling of the plug connector 1 or the external shocks.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A receptacle connector, comprising:
a receptacle housing, being made of insulating material and having two opposite end walls, two sidewalls connected to the two end walls, and a bottom plate connecting bottoms of the two end walls and the two sidewalls;
a protruding plate, standing on the bottom plate and being parallel to and located between the two sidewalls, two opposite ends of the protruding plate and the two sidewalls being spaced a distance;
a plurality of terminal-receiving grooves, each of which is together defined by the protruding plate, the sidewall and the bottom plate, the terminal-receiving grooves being spaced each other and passing through top and bottom surfaces of the bottom plate and the two sidewalls;
two engaging grooves, being respectively formed between the protruding plate and the two sidewalls and being communicated with the terminal-receiving grooves; and
a plurality of receptacle terminals, being mounted in the terminal-receiving grooves from the below of the bottom plate; each of the receptacle terminals including a connecting section, a pressing section and a positioning section;
the pressing section and the positioning section being respectively bent from two ends of the connecting section and being spaced each other; and the positioning section being inverted U-shaped and located in the sidewall of the receptacle housing;
wherein the protruding plate forms a resisting wall corresponding to the pressing section, the resisting wall being sloped down from the engaging groove to the inner of the protruding plate, the pressing section being tilted toward the positioning section, the pressing section and the resisting wall maintaining an interval, the pressing section disposing at least a first wing portion, and the protruding plate forming a shoulder corresponding to the first wing portion.

2. The receptacle connector as claimed in claim 1, wherein the positioning section disposes at least a second wing portion, and the sidewall of the receptacle housing forms a shoulder corresponding to the second wing portion.

3. The receptacle connector as claimed in claim 1, wherein the first wing portion protrudes on two opposite sides of the pressing section and extends toward the two end walls of the receptacle housing.

4. The receptacle connector as claimed in claim 1, wherein the pressing section further disposes a first edge portion, which is formed on one end thereof away from the connecting section and is exposed in the engaging groove; the positioning section disposes a second edge portion, which is formed on one end thereof adjacent to the engaging groove and is sloped downward from the engaging groove to the sidewall of the receptacle housing for forming a ridge portion; and the ridge portion is exposed in the engaging groove.

5. The receptacle connector as claimed in claim 4, wherein the first edge portion is bent to form an arc surface, and the positioning section is bent to form a solder portion on the other end thereof opposite to the connecting section.

6. The receptacle connector as claimed in claim 1, wherein each end wall of the receptacle housing forms a positioning groove on the outside thereof for accommodating a flux member.

7. A plug connector, comprising:
a plug housing, being made of insulating material and having two opposite end walls, two sidewalls connected to the two end walls and spaced each other, and a bottom plate connecting bottoms of the two end walls and the two sidewalls;
an inserting groove, being defined by the two end walls, the two sidewalls and the bottom plate; and
a plurality of plug terminals, being spaced each other and being orderly arranged on the two sidewalls, and each plug terminal including a latch section, which is U-shaped and forms an interference section and a contact section on two opposite ends thereof;
wherein the interference section disposes a first contact portion being adjacent to and opening to the inserting groove; the contact portion disposing a second contact portion, which is concaved inward from one surface of the contacting section; one end of the interference section being further bent and extending to form a solder portion, which is partially located in the bottom plate and which is partially exposed out of the plug housing; the part of the solder portion embedded in the bottom plate being located above the contacting section and being together with the contacting section to clamp the bottom plate.

8. The plug connector as claimed in claim 7, wherein the first contact portion of the interference section is a recess, which is concaved inward from one surface of the interference section.

9. The plug connector as claimed in claim 7, wherein the second contact portion of the interference section is a platform, and an inner surface of the latch section is attached to the sidewall of the plug housing.

10. The plug connector as claimed in claim 7, further comprising two flux members, which are respectively mounted in the two end walls of the plug housing.

11. An electrical connector assembly, comprising a receptacle connector and a plug connector;
the receptacle connector, comprising:
a receptacle housing, being made of insulating material and having two opposite end walls, two sidewalls connected to the two end walls, and a bottom plate connecting bottoms of the two end walls and the two sidewalls;
a protruding plate, standing on the bottom plate and being parallel to and located between the two sidewalls, two opposite ends of the protruding plate and the two sidewalls being spaced a distance;
a plurality of terminal-receiving grooves, each of which is together defined by the protruding plate, the sidewall and the bottom plate, the terminal-receiving grooves being spaced each other and passing through top and bottom surfaces of the bottom plate and the two sidewalls;
two engaging grooves, being respectively formed between the protruding plate and the two sidewalls and being communicated with the terminal-receiving grooves; and
a plurality of receptacle terminals, being mounted in the terminal-receiving grooves from the below of the bottom plate; each of the receptacle terminals including a connecting section, a pressing section and a positioning section;
the pressing section and the positioning section being respectively bent from two ends of the connecting section and being spaced each other; and the positioning section being inverted U-shaped and located in the sidewall of the receptacle housing;
wherein the protruding plate forms a resisting wall corresponding to the pressing section, the resisting wall being sloped down from the engaging groove to the inner of the protruding plate, the pressing section and the resisting wall maintaining an interval, the pressing section disposing at least a first wing portion, the protruding plate forming a shoulder corresponding to the first wing portion, and the connecting section being parallel to the bottom plate of the receptacle housing; and
the plug connector, comprising:
a plug housing, being made of insulating material and having two opposite end walls, two sidewalls connected to the two end walls and spaced each other, and a bottom plate connecting bottoms of the two end walls and the two sidewalls;
an inserting groove, being defined by the two end walls, the two sidewalls and the bottom plate; and
a plurality of plug terminals, being spaced each other and being orderly arranged on the two sidewalls, and each plug terminal including a latch section, which is U-shaped and forms an interference section and a contact section on two opposite ends thereof;
wherein the interference section disposes a first contact portion being adjacent to and opening to the inserting groove; the contact portion disposing a second contact portion, which is concaved inward from one surface of the contacting section; one end of the interference section being further bent and extending to form a solder portion, which is partially located in the bottom plate and which is partially exposed out of the plug housing; the part of the solder portion embedded in the bottom plate being located above the contacting section and being together with the contacting section to clamp the bottom plate.

12. The electrical connector assembly as claimed in claim 11, wherein the positioning section of the receptacle terminal of the receptacle connector disposes at least a second wing portion, and the sidewall of the receptacle housing forms a shoulder corresponding to the second wing portion.

13. The electrical connector assembly as claimed in claim 11, wherein the first wing portion of the receptacle terminal protrudes on two opposite sides of the pressing section and extends toward the two end walls of the receptacle housing.

14. The electrical connector assembly as claimed in claim 11, wherein the pressing section of the receptacle terminal of the receptacle connector further disposes a first edge portion, which is formed on one end thereof away from the connecting section and is exposed in the engaging groove; the positioning section disposes a second edge portion, which is formed on one end thereof adjacent to the engaging groove and is sloped downward from the engaging groove to the sidewall of the receptacle housing for forming a ridge portion; and the ridge portion is exposed in the engaging groove.

15. The electrical connector assembly as claimed in claim 14, wherein the first edge portion of the receptacle terminal is bent to form an arc surface, and the positioning section is bent to form a solder portion on the other end thereof opposite to the connecting section.

16. The electrical connector assembly as claimed in claim 11, wherein the plug connector further comprises two flux members respectively mounted on the two end walls of the plug housing.

17. The electrical connector assembly as claimed in claim 11, wherein the first edge portion of the receptacle terminal is bent to form an arc surface, the positioning section of the receptacle terminal disposes a second edge portion adjacent to the engaging groove, two opposite sides of the second edge portion dispose a second wing portion, and the positioning section is bent to form a solder portion on the other end thereof.

18. The electrical connector assembly as claimed in claim 11, wherein the resisting wall of the receptacle housing is a slope standing on the bottom plate, and the pressing section and the resisting wall have a same inclined angle.

19. The electrical connector assembly as claimed in claim 11, wherein each end wall of the receptacle housing forms a positioning groove on the outside thereof for accommodating a flux member.
